(19) United States
(12) Patent Application Publication
(10) Pub. No.: US 2015/0074260 A1
(43) Pub. Date: Mar. 12, 2015

(54) AUTO DISCOVERY AND TOPOLOGY RENDERING IN SUBSTATION NETWORKS

(71) Applicant: Cisco Technology, Inc., San Jose, CA (US)

(72) Inventors: Chethan Anand B.S., Bangalore (IN); Jun Zha, Palo Alto, CA (US); Vivek Thakare, Bangalore (IN)

(73) Assignee: CISCO TECHNOLOGY, INC., San Jose, CA (US)

(21) Appl. No.: 14/024,378

(22) Filed: Sep. 11, 2013

(51) Int. Cl. H04L 12/26

(52) U.S. Cl. CPC H04L 43/045
USPC 709/224

(57) ABSTRACT

System, method, and computer program product to capture, at a first network element in a substation network, a first data packet transmitted according to a predefined protocol, compare a MAC address of the first data packet to a MAC address table of at least one of the plurality of network elements, upon determining that the MAC address of the first data packet is defined in the MAC address table as belonging to a first substation power device, identify, from the MAC address table, a first port of a first network element, that the first substation power device is connected to, and retrieve, from a Substation Configuration Language file, a name for the first substation power device based on a logical node name in the first data packet, and generate a visual depiction of a network topology of the plurality of network elements and the first substation power device.

### TECHNICAL FIELD

Embodiments presented in this disclosure generally relate to computer networking, and more specifically, to auto discovery and topology rendering in substation networks.

### BACKGROUND

Electrical grids are complex systems, and will likely continue to get more complex over time. An electrical grid may typically include a generating station, transmissions network, and distribution system which delivers power to end consumers. A utility company is typically in charge of managing the grid and ensuring that the power demand is met. The entire grid, including the substations, is typically managed and monitored from a control center.

Recently, smart grid infrastructure and technologies have been developed to make the electrical grid more intelligent and self-managing. These developments include IP-based standards intended to replace serial, copper-based communications networks, and allow the substations themselves to become self-managing. However, adoption of these standards has been slow, as traditional management systems are not sufficient to manage the grids. That is, traditional management systems lack the requisite means to ensure stability, availability, and to maintain the quality of the energy supplied by the grids. Furthermore, these traditional management systems cannot determine and visualize a topology of the electrical grids, slowing the adoption of the new IP-based standards.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates techniques for auto discovery and topology rendering in substation networks, according to one embodiment.

FIG. 2 illustrates a logical view of techniques for auto discovery and topology rendering in substation networks, according to one embodiment.

FIG. 3 illustrates a method for auto-discovery and topology rendering in substation networks, according to one embodiment.

FIG. 4 illustrates a system for auto-discovery and topology rendering in substation networks, according to one embodiment.

### DESCRIPTION OF EXAMPLE EMBODIMENTS

### Overview

System, method, and computer program product to perform an operation, comprising capturing, at a first network element of a plurality of network elements in a substation network, a first data packet transmitted according to a predefined networking protocol, comparing a media access control (MAC) address of the first data packet to a MAC address table of at least one of the plurality of network elements, upon determining that the MAC address of the first data packet is defined in the MAC address table as belonging to a first substation power device of a plurality of substation power devices in the substation network, identifying, from the MAC address table, a first port of a first network element of the plurality of network elements, that the first substation power device is connected to, and retrieving, from a Substation Configuration Language (SCL) file, a name for the first substation power device based on a logical node name in the first data packet, and generating a visual depiction of a network topology of the plurality of network elements and the first substation power device.

### Example Embodiments

Embodiments disclosed herein provide techniques to discover network elements in a substation network and to visualize a topology of the substation network. Examples of network elements in a substation network may include, but are not limited to, communication devices such as routers, switches, and the like. Intelligent Electronic Devices (IEDs) may also make up part of the substation network, and are microprocessor-based controllers of power system equipment, such as circuit breakers, transformers, capacitor banks, and the like. Generally speaking, embodiments disclosed herein provide techniques for discovering and visualizing a substation network's topology, by discovering the communication devices within the network and the IEDs connected to them. In order to discover the IEDs, embodiments may analyze packets sent through the communication devices in order to capture source and destination media access control (MAC) addresses of all devices generating network traffic. By referencing MAC address tables in the communication devices (switches, routers, etc.), embodiments may identify devices defined as IEDs. In at least one embodiment, the data packets are layer 2 (L2) packets structured according to the Generic Object Oriented Substation Events (GOOSE) control model mechanism.

In order to build the network topology, embodiments disclosed herein may leverage Substation Configuration Language (SCL) files, which are present in all substations adopting the International Electrotechnical Commission (IEC) 61850 standard, in order to obtain details specific to each IED. The SCL files may capture device entities in the network, with an entity's function being described as a logical node (with a corresponding logical node name) in the SCL file. GOOSE data packets include a logical node name in the message body. Therefore, for a given data packet with a MAC address that has been verified against the MAC address table in the communication devices, the logical node name may be extracted and referenced against logical node names in the SCL file. Once the logical node name is identified in the SCL file, properties of the IED may also be retrieved from the SCL file, the properties including, but not limited to an IED type, an IED name, a configuration version, a unique identifier, a manufacturer identifier, and the like, may also be retrieved from the SCL file. Devices not defined as IEDs in the SCL file may be ignored. Once the relevant topology and identification information are gathered, embodiments disclosed herein may generate a visual description of the network topology.

One of ordinary skill in the art would recognize that SCL files, GOOSE packets, and IEC standards are used herein as reference examples only, and should not be considered limiting of the disclosure, as any range of suitable configuration files, structured data packets, and standards may be used to implement the techniques described herein. As used herein, “communication devices” includes, but is not limited to, IP-based networking hardware, such as switches, routers, and the like.

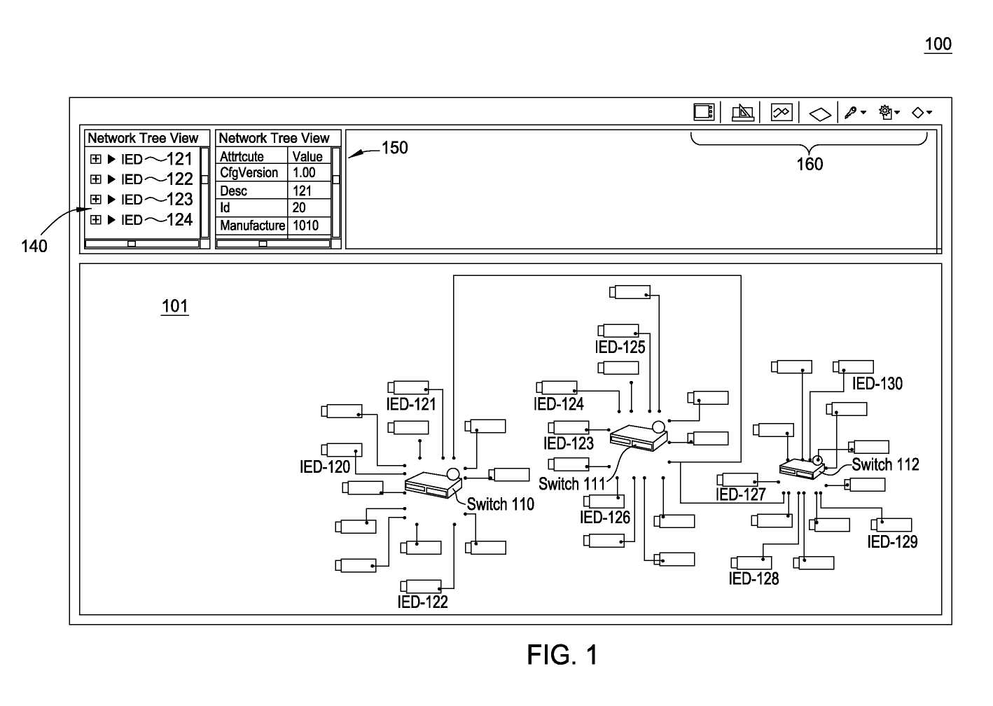

FIG. 1 depicts a graphical user interface (GUI) 100 for auto discovery and topology rendering in substation networks, according to one embodiment. As shown, the GUI 100 includes a detailed network topology 101. In one embodiment, the network topology 101 depicts connections between devices in a substation network. The programmatically generated network topology 101 includes three switches 110, 111, and 112. Each switch 110-112 is connected to a respective network of substation devices, including a plurality of IEDs 120-130. For example, IED-120, IED-121, and IED-122 are connected to switch 110, while IED-123, IED-124, IED-125, and IED-126 are connected to switch 111, and IED-127, IED-128, IED-129, and IED-130 are connected to switch 112. To preserve clarity, not all IEDs have been labeled. The GUI 100 also includes a network tree view 140, which includes a detailed listing of each of the identified IEDs in the network topology. Selection of an IED listed in the network tree view 140 (or the network topology 101) causes properties of the IED to be displayed in the device properties view 150. A description of any number of different properties may be provided in the device properties view 150. As shown, the device properties view 150 depicts a configuration version of 1.00, description of IED-121, an ID of 20, and manufacturer 1010. A plurality of buttons 160 allows a user to create a new network topology 101, refresh the currently displayed topology, adjust configuration settings, and the like.

In order to render the network topology 101, a user may provide an identifier (such as an IP address) of a communication device (such as a switch in the substation network) to an application configured to generate the GUI 100. Based on this identifier, the application may discover other communication devices in the network using existing discovery protocols (such as the Cisco® Discovery Protocol, CDP) in a network management system (NMS, not pictured). Existing network discovery protocols, however, cannot discover IEDs, and cannot retrieve information regarding the IEDs. To this end, the application may capture GOOSE packets transferred by the IEDs through each of the switches in order to identify the MAC addresses of IEDs generating the packets. The application may capture packets for a predetermined period of time, and then analyze each of the packets in turn as described herein. For example, a first GOOSE packet may be captured, and the MAC address of the sender may be extracted. The application may take the extracted MAC address and reference a MAC address table on the switch to determine whether the MAC address belongs to an IED, and if so, what port of the switch the IED is connected to. Once the application knows that the MAC address belongs to an IED, the application may extract a logical node name from the GOOSE message body. The application may then use the logical node name extracted from the first data packet to identify a corresponding logical node name in the SCL file. Once the logical nodes are identified, the corresponding IED may be identified in the SCL file, and the application may retrieve the properties of the IED specified in the SCL file. For each identified IED, the application may store a reference in a data structure for the IED, which may include the IED properties and location in the network, in order to generate the network topology 101 and populate the relevant details in the network tree view 140 and device properties view 150.

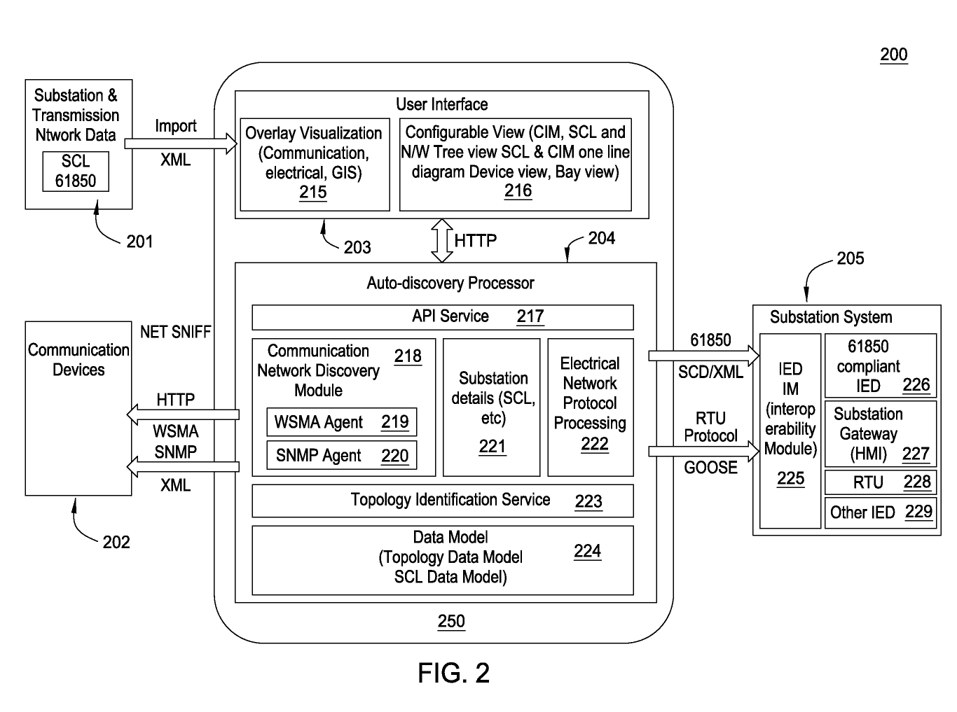

FIG. 2 illustrates a block diagram 200 illustrating a logical view of techniques for auto discovery and topology rendering in substation networks, according to one embodiment. An application 250 may include a user interface 203 and an auto-discovery processor 204. The application 250 may be used to discover communication devices 202 and IEDs 226 and 229 (and other devices) in the substation system 205, and present a network topology to the user through the user interface 203. The application 250 imports substation & transmission network data 201 (e.g., data implementing the IEC 61850 standard). The user interface 203 includes an overlay visualization 215 and configurable view 216. The overlay visualization 214 provides a visualization of communication, electrical system, and geographic information system (GIS) data of the substation and transmission network data 201. The configurable view 216 provides different views of a network, including, but not limited to, a common information model (CIM), SCL, and network tree view, a device view, a bay view, and an SCL and CIM one line diagram.

The auto-discovery processor 204 includes an application program interface (API) service 217, a substation details 221, an electrical network protocol processing 222, a topology identification service 223, and a data model 224. The API service 217 provides APIs used by the application 250, as well as other devices and applications in the network, to provide a common framework for exposing and exchanging information. The communication network discovery is a module generally configured to discover communication devices in the substation network, and includes web services management (WSMA) agent 219 and a simple network management protocol (SNMP) agent 220. The WSMA agent 219 defines a set of web services, through which a network device can be fully managed, from configuration to on-going monitoring to troubleshooting, over the HTTP protocol. The SNMP agent 220 provides protocols used to discover, monitor, and manage devices on a network. The communication network discovery module 218 may be used to discover one or more communication devices 202. The communication devices 202 may include, but are not limited to, network adapters, routers, switches, and the like.

The substation details 221 may be a file including detailed information about all devices in a substation network. One example of the substation details 221 is a substation configuration language (SCL) file. An electrical network protocol processing module 222 communicates with a substation system 205 through one or more protocols, including the RTU Protocol and GOOSE. The topology identification service 223 represents a service generally configured to generate a network topology for a substation network. The data model 224 represents a data model used to provide a standard format for the network topology generated by the application 250, as well as the SCL data model implemented in substation details 221.

The substation system 205 includes an IED-M (interoperability module) 224, a plurality of IEC 61850 compliant IEDs 226, a substation gateway 227, a remote terminal unit (RTU) 228, and other IEDs 229. The IED-M 224 may be an interfacing module which helps facilitate communications across different substation sub-systems, such as an HMI (human machine interface) and an RTU. Generally, the IEDs 226 and 229 control power system equipment, such as circuit breakers, transformers, and capacitor banks. The RTU 228 monitors and transmits telemetry data to a master system, such as the application 250. The substation gateway 227 serves as a human machine interface (HMI) between hardware in the substation system 205 and users.

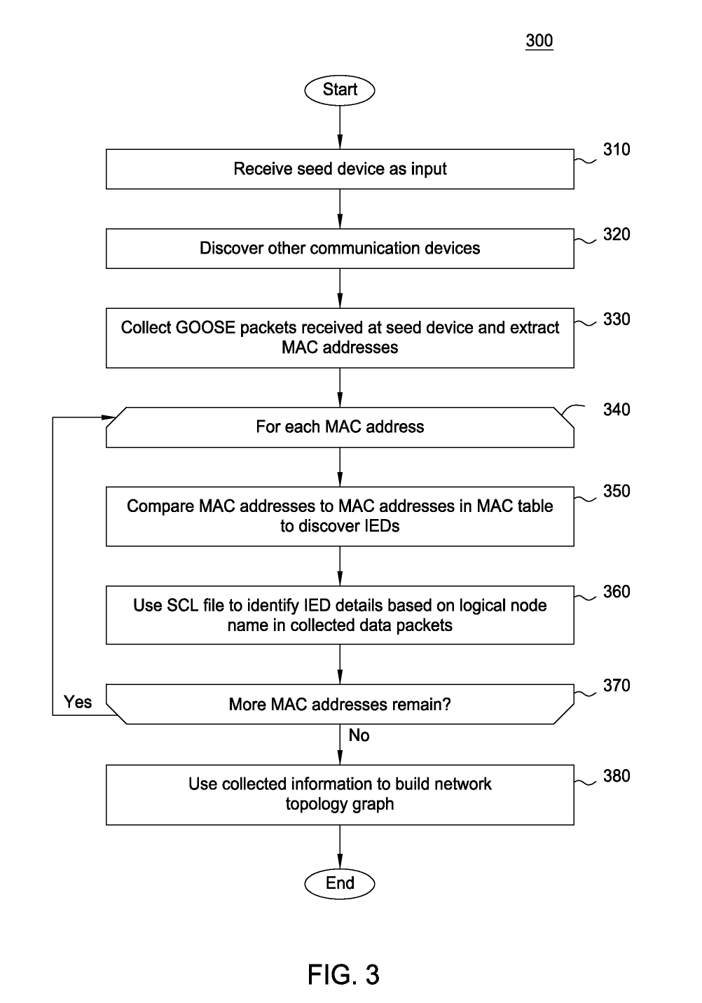

FIG. 3 illustrates a method 300 for auto-discovery and topology rendering in substation networks. Generally, a system (or application) executing the method 300 could discover communication devices and IEDs in a substation network, retrieve details related to the IEDs, and output a graph depicting a detailed topology of the substation network. At block 310, the system may receive a seed device as input. The seed device may be a communication device, such as a router or switch in a substation network, and may be provided programmatically or by a user. Using the seed device as a starting point, the system discovers other communication devices (switches and routers) at block 320. In one embodiment, the system make take the seed device and use an SNMP command to find, for each port of the seed device, MAC addresses and/or IP addresses of other communication devices connected to seed device. The system may repeat this process for discovered devices in order to discover a complete network topology of communication devices in the substation network.

At block 330, the system collects GOOSE packets received at the seed device for a predefined period of time. Source and destination MAC addresses may also be extracted from the collected GOOSE packets. Any suitable network analyzer software, such as the virtual network analysis module (VNAM) by Cisco Systems, Inc., may be used to collect the GOOSE data packets. The predefined period of time may be any time sufficient to collect packets from the IEDs, which, in at least some embodiments comprises a few minutes. In one embodiment, the system may monitor packets at one, several, or all of the discovered communication devices in the substation network, in addition to the seed device. IEDs typically communicate using layer 2 GOOSE messages, therefore, the network analyzer software may be configured to collect L2 GOOSE data packets. In one embodiment, in order to extract the MAC addresses, the collected data packets are read using a GOOSE message parser, which obtains the source and destination MAC address from the header of the GOOSE protocol. At block 340, a loop including blocks 350-370 is executed for each MAC address collected at block 330.

At block 350, the current MAC address is compared to MAC addresses in the seed device's MAC address table. If the MAC address is defined as belonging to an IED, the system has discovered an IED and the port of the seed device that it is connected to. If the MAC address does not belong to an IED, the packet is not processed further, and the device may be ignored in generating the network topology. At block 360, if the MAC address belongs to an IED, the system extracts the logical node name from the GOOSE message body of the packet that the MAC address was extracted from. Once the logical node name is identified, the system may reference the SCL file to identify the IED that the logical node name is associated with. In one embodiment, the SCL file includes, for each IED, N logical node names. The SCL file may also include details about the IED, including, but not limited to, its name, model number, hardware version, software versions, and the like. In at least some embodiments, the system may store the IED information (including connectivity information) in a data structure used to generate the network topology graph. At block 370, the system determines whether more MAC addresses remain to be analyzed. If more MAC addresses remain, the system returns to block 340. Otherwise, all captured MAC addresses have been analyzed, and the system proceeds to block 380, where it uses the collected information to build a network topology graph of the substation network.

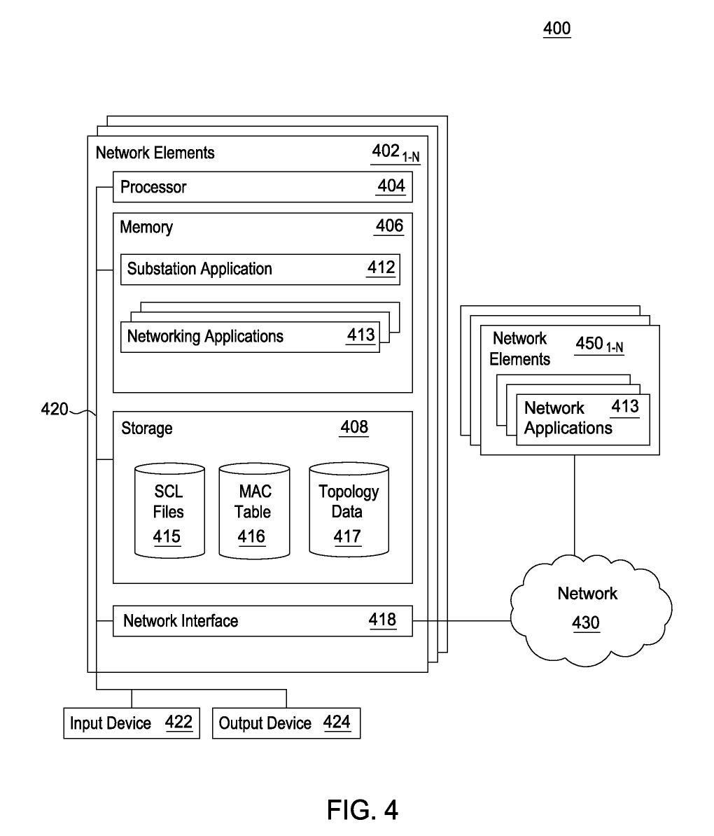

FIG. 4 illustrates a system 400 for auto-discovery and topology rendering in substation networks, according to one embodiment. As shown, network elements 402_{1-N} are connected via a network 430 to other network elements 402_{1-N} and other network elements 450_{1-N}. In one embodiment, the network elements 402_{1-N} comprise communication devices such as switches and routers, while the network elements 450_{1-N} comprise IEDs and other electrical grid hardware. In embodiments where the network elements 450_{1-N} are IEDs, the network elements 450_{1-N} are microprocessor (not shown) based controllers configured to monitor and control power substation equipment, such as circuit breakers, transformers, and capacitor banks. In general, the network 430 may be a telecommunications network and/or a wide area network (WAN). In a particular embodiment, the network 430 is the Internet.

Each network element 402_{1-N} has a processor 404 connected via a bus 420 to a memory 406, and a network interface device 418. The network elements 402_{1-N} are configured to execute containerized software applications. The network elements 402_{1-N} are generally under the control of an operating system (not shown). Examples of operating systems include the UNIX® operating system, distributions of the Linux® operating system, and the IOS operating system by Cisco Systems®. The processor 404 is included to be representative of a single CPU, multiple CPUs, a single CPU having multiple processing cores, and the like. The processor 404 may execute software developed for the purposes of embodiments disclosed herein. Similarly, the memory 406 may be a random access memory. While the memory 406 is shown as a single identity, it should be understood that the memory 406 may comprise a plurality of modules, and that the memory 406 may exist at multiple levels, from high speed registers and caches to lower speed but larger DRAM chips. The network interface device 418 may be any type of network communications device allowing the network elements 402_{1-N} to communicate with other network elements 402_{1-N}, 450_{1-N}, and other devices via the network 430.

As shown, the memory 404 includes a substation application 412, which is an application generally configured to discover communication devices (switches, routers, etc) and IEDs in a substation network, and to generate a network topology depicting the network configuration. To discover the communications devices, the substation application 412 could take a seed communication device as input, and could use existing network discovery methods to discover all IP-enabled communications devices (and endpoints) in the network. Once the IP-based communications network is discovered, the substation application 412 may store this information in the topology data 417 for use in generating the network topology graph. The substation application 412 may then collect packets on the seed device (and in some embodiments, one or more of the communications devices) for a predefined period of time. In at least some embodiments, the substation application 412 is configured to collect layer 2 GOOSE packets. The substation application 412 may extract source and/or destination MAC addresses from the packets.

The substation application 412 may then compare the extracted MAC addresses to addresses in the MAC address table 416 residing in the communications devices, which may specify whether the device is an IED, and which port of the communication device the IED is connected to. If the device is an IED, the substation application 412 may extract a logical node name from the packet including the MAC address determined to belong to an IED. Using the logical node name from the body of the GOOSE packet, the substation application 412 may then reference an SCL file in the SCL files 415, to retrieve details of the IED having the logical node name. The substation application 412 may then store the connectivity information for the IED and the IED details in the topology data 417. Once the substation application 412 has processed all MAC addresses captured during the collection period, the substation application 412 generates a network topology graph depicting all communications devices and IEDs in the substation network, and outputs the graph for display. The substation application 412 may execute on periodic intervals to account for any changes and show the current state of the network in near real time. With minor modifications, the substation application 412 may be configured to cover the distributed network protocol DNP3.

As shown, the memory 404 also includes a set of networking applications 413. The networking applications 413 may be a suite of applications that control the core functionality of the network elements 402_{1-N} and 450_{1-N}. For example, the networking applications 413 may include, but are not limited to, routing engines, a routing information base (RIB), GOOSE messaging protocols, discovery protocols, and the like.

As shown, the storage 408 includes SCL files 415, a MAC table 416, and a topology data 417. The SCL files 415 may store substation configuration language (SCL) files. As discussed above, SCL is the language and representation format specified by IEC 61850 for the configuration of electrical substation devices. An SCL file includes a representation for substation device entities, with its associated functions represented as logical nodes, communication systems and capabilities. The complete representation of data as SCL enhances the different devices of a substation to exchange the SCL files and to have a complete interoperability. The MAC table 416 may be a list of MAC addresses, specifying what devices are connected through which port of the network element 402_{1-N}, as well as their capabilities and types. The topology data 417 includes detailed information gathered by the substation application 412 regarding communications devices, IEDs, and other devices in the substation network. The topology data 417 may include, for example, connectivity information used to generate a graph of communications devices and IEDs, as well as detailed properties of the IEDs themselves, such as name, version, type, manufacturer, and the like. The graph generated by the substation application 412 may depict the substation network topology, as well as detailed information for each IED in the substation network.

Advantageously, embodiments disclosed herein render a communication topology of a substation network, which may assist utility engineers who do not understand IP to gain a clear picture of the substation network. Discovery and topology rendering are fully automated, zero touch processes. Embodiments disclosed herein leverage data from different sources, such as SCL files, device data, and network traffic to discover the devices and render the topology. Furthermore, the discovery and topology rendering techniques disclosed herein may facilitate adoption of new standards, and may be applied to hardware from different vendors applying these standards.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications, such as the substation application, or related data available in the cloud. For example, the substation application could execute on a computing system in the cloud and discover a topology of IEDs in a substation network. In such a case, the substation application could generate a network topology graph of the substation and store the generated graph at a storage location in the cloud. Doing so allows a user to access this information from any computing system attached to a network connected to the cloud (e.g., the Internet).

As will be appreciated by one skilled in the art, embodiments may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
capturing, at a first network element of a plurality of network elements in a substation network, a first data packet transmitted according to a predefined networking protocol;
comparing a media access control (MAC) address of the first data packet to a MAC address table of at least one of the plurality of network elements;
upon determining that the MAC address of the first data packet is defined in the MAC address table as belonging to a first substation power device of a plurality of substation power devices in the substation network:
identifying, from the MAC address table, a first port of a first network element of the plurality of network elements, that the first substation power device is connected to; and
retrieving, from a Substation Configuration Language (SCL) file, a name for the first substation power device based on a logical node name in the first data packet; and
generating a visual depiction of a network topology of the plurality of network elements and the first substation power device.

2. The method of claim 1, wherein the visual depiction of the network topology depicts a connection between the first substation power device and the first network element and further includes the retrieved name for the first substation power device.

3. The method of claim 1, wherein the predefined networking protocol is a layer 2 Generic Object Oriented Substation Events (GOOSE) protocol.

4. The method of claim 1, further comprising:
upon determining that the MAC address of the first data packet is defined in the MAC address table is not defined as belonging to any of the plurality of substation power devices, discarding the first data packet.

5. The method of claim 1, wherein the first substation power device is selected from the group comprising: (i) an Intelligent Electronic Device (IED), (ii) a transformer, and (iii) a circuit breaker.

6. The method of claim 1, further comprising:
capturing a plurality of data packets during a predefined timing interval;
identifying a subset of the plurality of data packets having source MAC addresses defined in the MAC address table as belonging to a respective substation power device, of the plurality of substation power devices;
retrieving, from the SCL file, a name for each respective substation power device based on a logical node name in the respective data packet in the subset of data packets; and
generating a network topology of the substation network.

7. The method of claim 1, wherein the MAC address of the first data packet is at least one of: (i) a source MAC address, and (ii) a destination MAC address of at least one of the plurality of substation power devices in the substation network.

8. A computer program product, comprising:
a computer-readable storage medium having computer-readable program code embodied therewith, the computer-readable program code comprising:
computer-readable program code configured to capture, at a first network element of a plurality of network elements in a substation network, a first data packet transmitted according to a predefined networking protocol;
computer-readable program code configured to compare a media access control (MAC) address of the first data packet to a MAC address table of at least one of the plurality of network elements;
computer-readable program code configured to, upon determining that the MAC address of the first data packet is defined in the MAC address table as belonging to a first substation power device of a plurality of substation power devices in the substation network:
identify, from the MAC address table, a first port of a first network element of the plurality of network elements, that the first substation power device is connected to; and
retrieve, from a Substation Configuration Language (SCL) file, a name for the first substation power device based on a logical node name in the first data packet; and
computer-readable program code configured to generate a visual depiction of a network topology of the plurality of network elements and the first substation power device.

9. The computer program product of claim 8, wherein the visual depiction of the network topology depicts a connection between the first substation power device and the first network element and further includes the retrieved name for the first substation power device.

10. The computer program product of claim 8, wherein the predefined networking protocol is a layer 2 Generic Object Oriented Substation Events (GOOSE) protocol.

11. The computer program product of claim 8, further comprising:
computer-readable program code configured to, upon determining that the MAC address of the first data packet is defined in the MAC address table is not defined as belonging to any of the plurality of substation power devices, discard the first data packet.

12. The computer program product of claim 8, wherein the first substation power device is selected from the group comprising: (i) an Intelligent Electronic Device (IED), (ii) a transformer, and (iii) a circuit breaker.

13. The computer program product of claim 8, further comprising:
computer-readable program code configured to capture a plurality of data packets during a predefined timing interval;
computer-readable program code configured to identify a subset of the plurality of data packets having source MAC addresses defined in the MAC address table as belonging to a respective substation power device, of the plurality of substation power devices;
computer-readable program code configured to retrieve, from the SCL file, a name for each respective substation power device based on a logical node name in the respective data packet in the subset of data packets; and
computer-readable program code configured to generate a network topology of the substation network.

14. The computer program product of claim 8, wherein the MAC address of the first data packet is at least one of: (i) a source MAC address, and (ii) a destination MAC address of at least one of the plurality of substation power devices in the substation network.

15. A system, comprising:
one or more computer processors; and
a memory containing a program, which when executed by the one or more computer processors, performs an operation, the operation comprising:
capturing, at a first network element of a plurality of network elements in a substation network, a first data packet transmitted according to a predefined networking protocol;
comparing a media access control (MAC) address of the first data packet to a MAC address table of at least one of the plurality of network elements;
upon determining that the MAC address of the first data packet is defined in the MAC address table as belonging to a first substation power device of a plurality of substation power devices in the substation network:
identifying, from the MAC address table, a first port of a first network element of the plurality of network elements, that the first substation power device is connected to; and
retrieving, from a Substation Configuration Language (SCL) file, a name for the first substation power device based on a logical node name in the first data packet; and
generating a visual depiction of a network topology of the plurality of network elements and the first substation power device.

16. The system of claim 15, wherein the visual depiction of the network topology depicts a connection between the first substation power device and the first network element and further includes the retrieved name for the first substation power device.

17. The system of claim 15, wherein the predefined networking protocol is a layer 2 Generic Object Oriented Substation Events (GOOSE) protocol.

18. The system of claim 15, the operation further comprising:
upon determining that the MAC address of the first data packet is defined in the MAC address table is not defined as belonging to any of the plurality of substation power devices, discarding the first data packet.

19. The system of claim 15, wherein the first substation power device is selected from the group comprising: (i) an Intelligent Electronic Device (IED), (ii) a transformer, and (iii) a circuit breaker.

20. The system of claim 15, the operation further comprising:
capturing a plurality of data packets during a predefined timing interval;
identifying a subset of the plurality of data packets having source MAC addresses defined in the MAC address table as belonging to a respective substation power device, of the plurality of substation power devices;
retrieving, from the SCL file, a name for each respective substation power device based on a logical node name in the respective data packet in the subset of data packets; and
generating a network topology of the substation network.

21. The system of claim 15, wherein the MAC address of the first data packet is at least one of: (i) a source MAC address, and (ii) a destination MAC address of at least one of the plurality of substation power devices in the substation network.
